(19) United States
(12) Patent Application Publication
(10) Pub. No.: US 2015/0101041 A1
(43) Pub. Date: Apr. 9, 2015

(54) METHOD AND APPARATUS FOR USER AUTHENTICATION

(71) Applicant: Samsung Electronics Co., Ltd., Gyeonggi-do (KR)

(72) Inventors: Sendilramkumar DEVAR, Gujarat (IN); Neminath HUBBALLI, Karnataka (IN); Badrinath G. SRINIVAS, Karnataka (IN)

(21) Appl. No.: 14/497,995

(22) Filed: Sep. 26, 2014

(30) Foreign Application Priority Data
Oct. 3, 2013 (IN) 2920/DEL/2013

(51) Int. Cl. G06F 21/36

(52) U.S. Cl. CPC G06F 21/36
USPC 726/19

(57) ABSTRACT

A method for authentication is provided comprising: displaying, by an electronic device, a first screen including first objects, each first object being associated with a respective value; detecting a first gesture performed on a first set of the first objects; identifying a first operation based on the first gesture; performing, by the electronic device, the first operation using the respective values of the first objects in the first set as operands to obtain a first result; computing an input string based on the first result; detecting whether the input string matches a predefined password; and authorizing access to the electronic device in response to the input string matching the predefined password.

### CLAIM OF PRIORITY

This application claims priority under 35 U.S.C. §119(a) to Indian Patent Application Serial No. “2920/DEL/2013”, which was filed in the Indian Patent Office on “Oct. 3, 2013”, the entire disclosure of which is incorporated herein by reference.

### BACKGROUND

1. Field of the Disclosure

The present disclosure relates to electronic devices, and more particularly to a method and apparatus for user authentication.

2. Description of the Related Art

Many electronic devices, such as smartphones, are equipped with touchscreens. These touchscreens allow users to input data just by touching the electronic devices.

Over the years, authentication mechanisms have been developed that are specially adapted for touchscreen-based devices. These mechanisms permit users to unlock their devices via touch input. Specific examples of these mechanisms include pin-code-based lock mechanisms, password-based lock mechanisms, pattern-based lock mechanisms, face-recognition-based lock mechanisms, voice-recognition-based lock mechanisms, swipe-to-unlock, signature-based lock mechanisms, and the like. Swipe-to-unlock mechanisms provide no security at all as they permit a device to be unlocked by a simple sliding gesture. Pin-code-based and password-based lock mechanisms, on the other hand, provide a medium level of security. These mechanisms allow the user to unlock a given device by touching numbers displayed on the given device's screen or by drawing a pattern on the screen. However, one disadvantage of pin-code-based and password-based lock mechanisms is that they are vulnerable to shoulder surfing. Accordingly the need exists for new techniques for user authentication.

### SUMMARY

The present disclosure addresses this need. According to aspects of the disclosure, a method for authentication is provided comprising: displaying, by an electronic device, a first screen including first objects, each first object being associated with a respective value; detecting a first gesture performed on a first set of the first objects; identifying a first operation based on the first gesture and performing, by the electronic device, the first operation using the respective values of the first objects in the first set as operands to obtain a first result; computing an input string based on the first result to detect whether the input string matches a predefined password; and authorizing access to the electronic device in response to the input string matching the predefined password.

According to aspects of the disclosure, an apparatus for authentication is provided comprising a processing circuitry configured to: display a first screen including first objects, each first object being associated with a respective value; detect a first gesture performed on a first set of the first objects; identify a first operation based on the first gesture and perform the first operation using the respective values of the first objects in the first set as operands to obtain a first result; compute an input string based on the first result to detect whether the input string matches a predefined password; and authorize access to the apparatus in response to the input string matching the predefined password.

### BRIEF DESCRIPTION OF THE DRAWINGS

This disclosure is illustrated in the accompanying drawings, throughout which like reference letters indicate corresponding parts in the various figures. The embodiments herein will be better understood from the following description with reference to the drawings, in which:

FIG. 1 is a diagram of an example of a system 100, according to aspects of the disclosure;

FIG. 2 is a diagram of another example of the system 100, according to aspects of the disclosure;

FIG. 3 is a flowchart of an example of a method, according to aspects of the disclosure;

FIG. 4A, FIG. 4B, FIG. 4C, FIG. 4D, and FIG. 4E are diagrams illustrating an example of a process, according to aspects of the disclosure; and

FIG. 5 is a diagram of an example of a computing environment, according to aspects of the disclosure.

### DETAILED DESCRIPTION

The examples provided herein are explained more fully with reference to the accompanying drawings. Descriptions of well-known components and processing techniques are omitted so as to not unnecessarily obscure subject matter that is considered more pertinent. The examples provided herein are intended merely to facilitate an understanding of ways in which the concepts discussed in the present disclosure can be practiced and they should not be construed as limiting in any way. It should further be noted that the examples provided herein are not necessarily mutually exclusive, as some examples can be combined with one another. The term “or” as used herein, refers to a non-exclusive or, unless otherwise indicated.

According to aspects of the disclosure, a system and method for authenticating a user are disclosed. The system and method may associate an arithmetic or logical operation with a respective gesture. In operation, a user may perform a gesture on a plurality of objects displayed on an electronic device. Next, the arithmetic or logical operation associated with the gesture may be identified. An input string can then be computed by performing the identified arithmetic or logical operation on values associated with the objects. The electronic device may compare the input string with a predefined password and if the input string matches the predefined password, then the user is positively authenticated.

According to aspects of the disclosure, the method and system disclosed herein allow the user to input the password using a different gesture each time, thereby making it more difficult for imposters observing the user accessing the electronic device to replicate the correct unlocking pattern or code. This is achieved by randomly displaying the objects or the values associated with them every time the user tries to access the electronic device. The random display of the objects permits a different gesture to be used to unlock the electronic device every time the user tries to access the electronic device. Moreover, in some implementations, the user may be allowed to use the whole screen of the electronic device in order to avoid shoulder surfing.

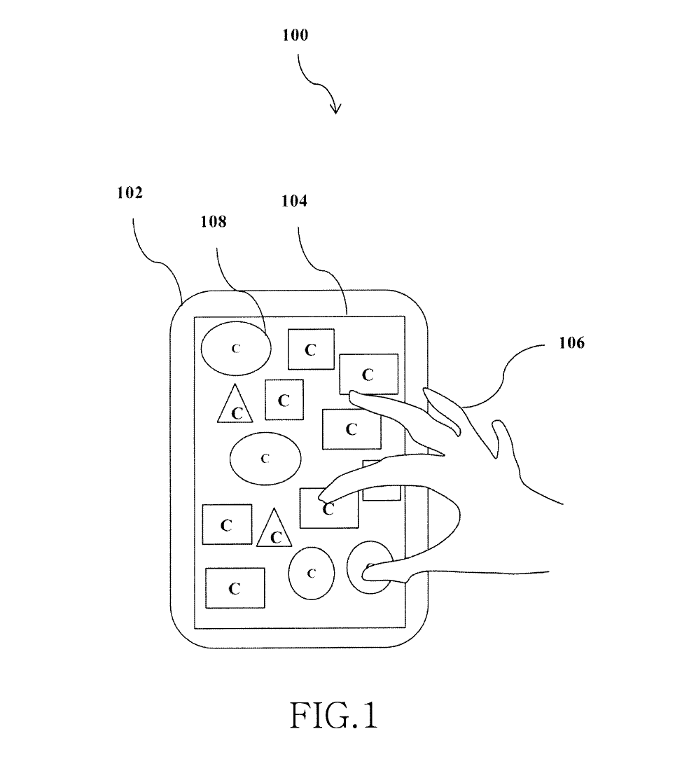

FIG. 1 is a diagram of an example of a system 100, according to aspects of the disclosure. In this example, the system 100 includes an electronic device 102. The electronic device 102 can include, for example and without limitation, a smartphone, tablet, laptop, computer, wired device, wireless device, communicator, portable electronic device, wearable computing device, flexible device, electronic kiosk, and the like. In some aspects, the electronic device 102 can include a touch surface 104 which senses any touch input that is received from user 106. A plurality of objects 108 associated with respective values (c) can be displayed on the electronic device 102 (however the value associated with each object may or may not be displayed). The values described herein can be letters, numbers, graphical representations, combination thereof, or any other character. The electronic device 102 can be configured to randomize the location and the values associated with the objects 108 each time before displaying them to the user 106. It is to be understood that FIG. 1 is provided as an example only and that system 100 may include additional and/or different components that are not shown in FIG. 1.

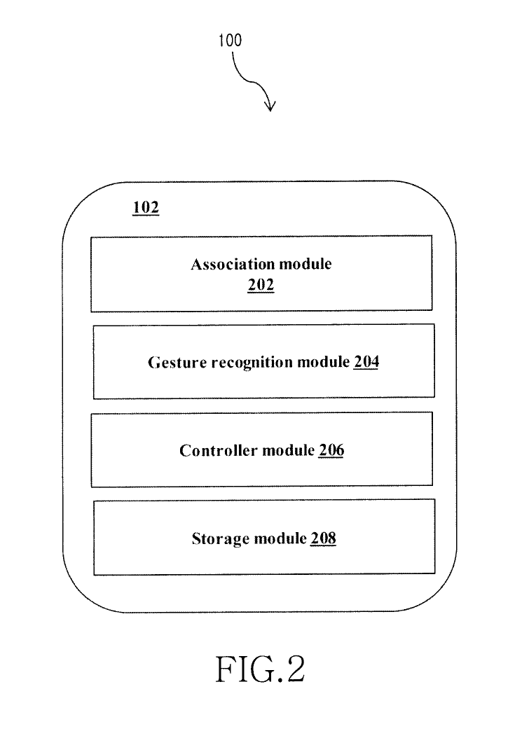

FIG. 2 is a diagram of another example of the system 100, according to aspects of the disclosure. In this example, the electronic device 102 can be configured to include an association module 202, a gesture recognition module 204, controller module 206, and storage module 208. In some aspects, the association module 202 can be configured to associate arithmetic and logical operations with respective gestures. The associated operations can then be performed on the respective values of different ones of the objects 108 on which the operation's respective gestures are performed. An example of a mapping between different gestures and associated arithmetic and logical operations is provided below:

TABLE 1
A Mapping Between Different
Gestures and Respective Operations

| Gesture | Operation |
|---|---|
| Pinch-out | Subtraction- |
| Pinch-in | Addition |
| Drag-drop | Compare |
| Rotate clockwise | Subtraction |
| Rotate anti-clockwise | Addition |
| Swirl clockwise | Division |
| Swirl anti-clockwise | Multiplication |

In some aspects, the gesture recognition module 204 can be configured to recognize a gesture performed by a user. The user may perform the gesture on multiple objects. The user may perform the gesture with or without touching the touch surface of the electronic device 102.

For example, but not limited to, the user may point the objects virtually in the electronic device 102 to establish the integration, may join fingers (such as thumb and forefinger) together to perform the gesture on the objects, may move hand in a waving motion without touching the touch surface of the electronic device 102 to perform the gesture, may use predefined signs, flags, arms, or strokes on the electronic device 102 for performing the gesture on the objects, and the like.

In some aspects, the controller module 206 can be configured to identify the operation associated with the gesture performed by the user. For each gesture, a substring that is part of a password can be computed by performing the operation associated with the gesture on the values associated with the objects on which the gesture is performed.

For example, a sequence of gestures results into a sequence of substrings and these substrings can be concatenated in order to form an input string. Further, the controller module 206 can be configured to compare the input string to a predefined password and provide access to the electronic device 102 when there is a match.

In some aspects, the storage module 208 can be configured to store the predefined password, arithmetic and logical operations, objects and the objects' respective values. In some aspects, the storage module 208 can be configured to store other instructions and signals required to process different operations of the electronic device 102. FIG. 2 is provided only for illustrative purposes and is not intended to limit the disclosure in any way.

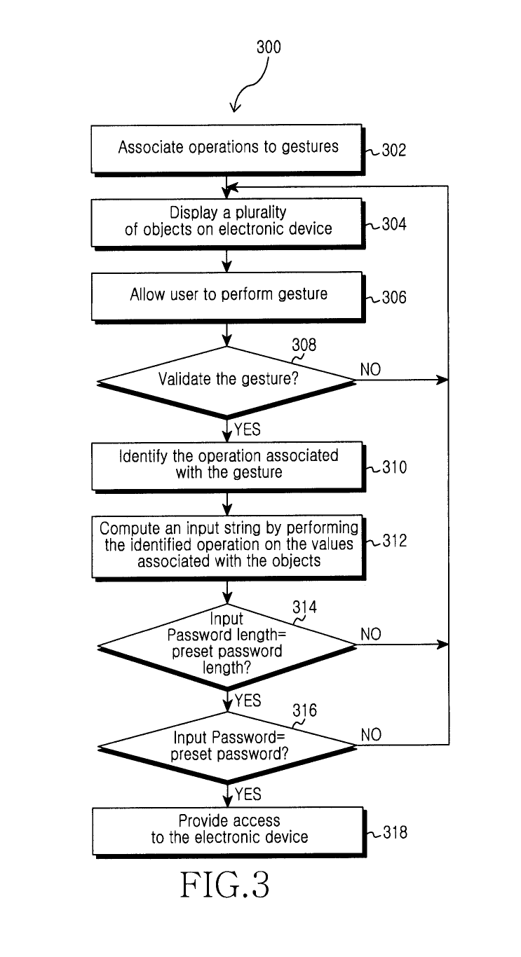

FIG. 3 is a flowchart of an example of a method 300, according to aspects of the disclosure. The method 300 and other description described herein provide a basis for a control program which can be implemented using a microcontroller, microprocessor, or an equivalent thereof.

At step 302, the method 300 includes associating operations with gestures. The operations described herein can include for example, but not limited to, arithmetic, logical, or any other type of operation. For example, one user may associate the pinch-in gesture with the addition operation and another user may associate the same gesture with a “concatenation operation” that results into characters being concatenated. Furthermore, some of the gestures can be set to generate NULL results irrespective of the associated values of the objects 108 on which the gestures are performed. Thus, the associations between different operations and their respective gestures may be customizable by the user. In some aspects, when the respective gesture of a particular operation is performed on some of the objects 108, the particular operation may be executed based on the values associated with the objects 108 on which the gesture is performed.

At step 304, the method 300 includes displaying the plurality of objects 108 on the electronic device 102. Each object 108 can be associated with a respective value (e.g., a character) displayed randomly on the electronic device 102.

At step 306, the method 300 includes allowing the user to perform a gesture on the displayed objects. For example, the user may perform the gesture by selecting different combinations of objects.

At step 308, the method 300 includes validating the gesture performed by the user. The electronic device 102 validates the gesture performed by the user by identifying the gesture using an association table. According to some aspects, the method 300 includes repeating the steps 302 to 308 in response to determining that the gesture performed by the user is invalid.

At step 310, the method 300 includes identifying the operation associated with the gesture performed by the user in response to determining that the gesture is valid. The method 300 allows the controller module 206 to identify the arithmetic or logical operation associated with the gesture in response to determining that the gesture performed by the user is valid.

At step 312, the method 300 includes computing an input string by performing the identified operation. For example, a substring for each gesture performed by the user can be computed by performing the operation associated with the gesture on the values associated with the objects 108 on which the gesture is performed. Thus, every time the user performs a valid gesture, the associated arithmetic or logical operation can be identified and performed on values associated with the objects 108 on which the gesture is performed. The result of the each operation can be appended to the results of previous operation(s) to produce an input string.

At step 314, the method 300 includes determining whether the length of the input string is equal to the length of the password. According to some aspects, the method 300 includes repeating the steps 302 to 314 in response to determining that the length of the input string is not equal to the length of the password.

At step 316, the method 300 includes comparing the input string to the predefined password in response to determining that the length of the input string is equal to the length of the predefined password. According to some aspects, the method 300 includes repeating the steps 302 to 316 in response to detecting that the input string does not match the predefined password.

At step 318, the method 300 includes providing access to the electronic device 102 in response to determining that the input string matches the predefined password. The method 300 allows the user to access the electronic device 102 upon determining that there is a match between the input string and the predefined password.

In some aspects, the some of the steps discussed with respect to FIG. 3 can be omitted, performed in parallel, or performed in a different order.

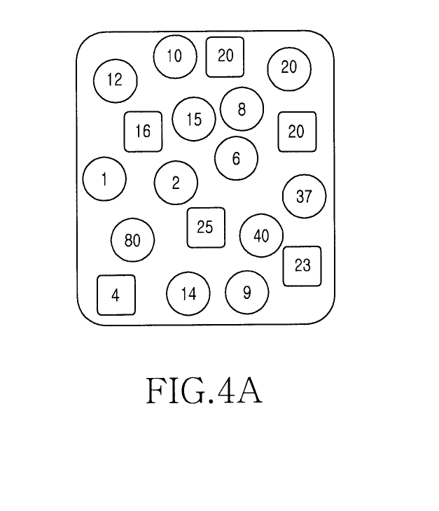

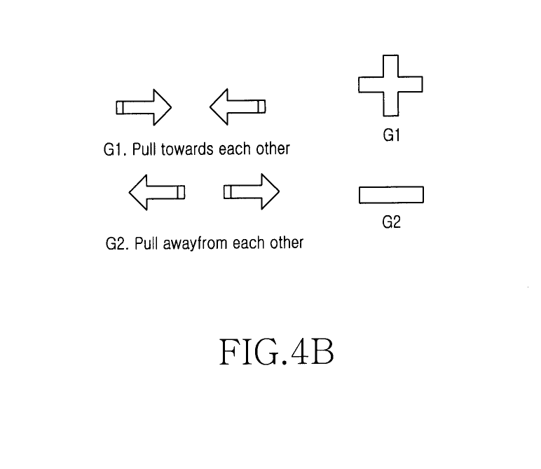

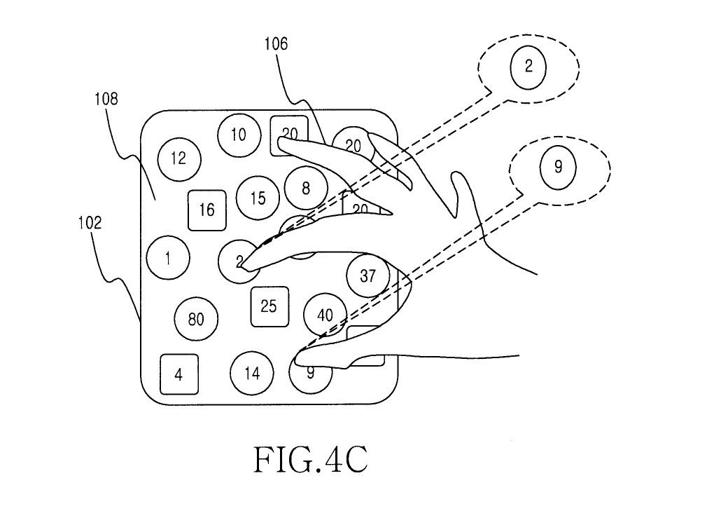

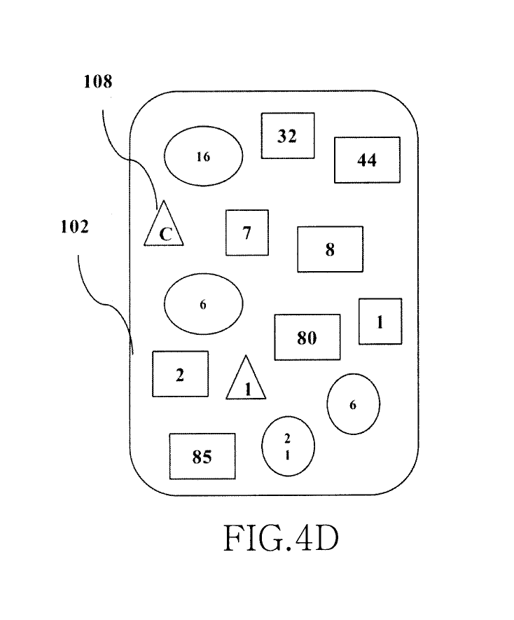

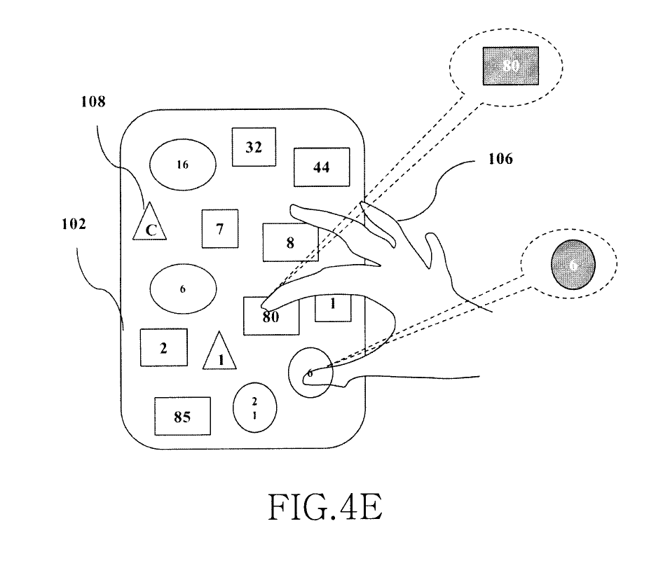

FIGS. 4A-E are diagrams illustrating an example of a process, according to aspects of the disclosure. In this example, the password to access the electronic device 102 is predefined as “1174”. The electronic device 102 displays a plurality of first objects as shown in FIG. 4a. Each first object is associated with a respective value such as, 1, 2, 14, 4 6, 8, 15, and the like. FIG. 4b shows respective arithmetic operations that are associated with gestures G1 and G2. Gesture (G1) is a pinch-in gesture associated with an addition operation and gesture (G2) is a pinch-out gesture associated with a subtraction operation. As shown in the FIG. 4c, the user performs gesture G1 on the first objects with associated values 2 and 9. The gesture G1 is associated the addition arithmetic operation and hence the result of this operation is 11. Note that there can be many other combinations of objects and gestures which the user can select to produce the substring 11.

After the addition operation is performed, the electronic device screen can be refreshed with a new set of set of second objects associated with respective values, as shown in FIG. 4d. As illustrated in FIG. 4e, the user may then perform the gesture G2 on two second objects having associated values of 80 and 6. The gesture G2 is associated with the subtraction arithmetic operation and hence the result of this operation is 74.

Furthermore, the electronic device 102 can be configured to concatenate or append the string 74 (generated using the G2 based arithmetic operation) with the string 11 (generated using the G1 based arithmetic operation) to produce an input string 1174. The electronic device 102 then compares the input string (1174) with the predefined password (1174) and because the input string matches the predefined password, the user is allowed to access the electronic device 102.

Although in the present example, the values associated with the objects are numerals, in other examples they may be other types of values. For example, the values associated with the objects can include pictures or other graphical representations. For example, a value (C1) can be a name of a person and another value (C2) can be a picture of an apple. When the user performs a gesture associated with a logical operation, such as AND or NOT, by selecting the objects associated with C1 and C2, the electronic device can perform a Boolean operation to determine whether the person likes or dislikes apple and computes the input string as “true” or “false”. The Boolean operation may be performed based on a logical association between the person name and their likes that is stored in the storage module 208. FIGS. 4A-E are provided as an example only and they are not intended to limit the disclosure in any way.

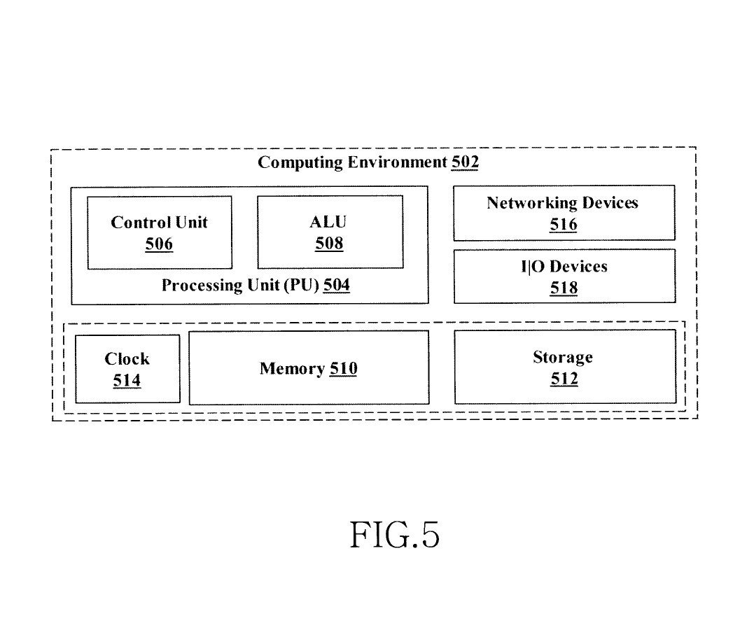

FIG. 5 is a diagram of an example of a computing environment 502, according to aspects of the disclosure. In this example, the computing environment 502 comprises at least one processing unit 504 that is equipped with a control unit 506 and an Arithmetic Logic Unit (ALU) 508, a memory 510, a storage unit 512, a clock chip 514, plurality of networking devices 516, and a plurality Input-Output (I/O) devices 518. In some implementations, the processing unit 504 could be configured to execute the processes discussed throughout the disclosure.

In some aspects, the computing environment 502 can be composed of multiple homogeneous and/or heterogeneous cores, multiple CPUs of different kinds, special media and other accelerators. In some aspects, the plurality of process units may be located on a single chip or over multiple chips.

An algorithm comprising instructions and codes required for implementation of the disclosed methods are stored in either the memory unit 510 or the storage 512 or both. During runtime, the instructions may be fetched from the corresponding memory 510 and/or storage 512, and executed by the processing unit 504. The processing unit 504 synchronizes the operations and executes the instructions based on the timing signals generated by the clock chip 514.

The foregoing description of the specific examples will so fully reveal the general nature of the examples disclosed herein that others can, by applying current knowledge, readily modify and/or adapt for various applications such specific examples without departing from the generic concept, and, therefore, such adaptations and modifications should and are intended to be comprehended within the meaning and range of equivalents of the disclosed examples. It is to be understood that the phraseology or terminology employed herein is for the purpose of description rather than limitation. It will be understood that the operations discussed with respect to FIGS. 1-5 are provided as an example only. At least some of those operations can be performed concurrently, performed in a different order, or altogether omitted. It will further be understood that the provision of the examples described herein (as well as clauses phrased as “such as,” “e.g.”, “including”, “in some aspects”, “according to aspects”, “may”, “can”, and the like) should not be interpreted as limiting the claimed subject matter to the specific examples; rather, the examples are intended to illustrate only some of many possible aspects.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. Any suitable type of processing circuitry can be used to implement the functions and steps provided in the Figures, such as at least one of a microcontroller, a microprocessor, a processing unit, and a general purpose processor. No claim element herein is to be construed under the provisions of 35 U.S.C. 112, sixth paragraph, unless the element is expressly recited using the phrase “means for”.

What is claimed is:

1. A method for authentication comprising:
displaying, by an electronic device, a first screen including first objects, each first object being associated with a respective value;
detecting a first gesture performed on a first set of the first objects;
identifying a first operation based on the first gesture and performing, by the electronic device, the first operation using the respective values of the first objects in the first set as operands to obtain a first result;
computing an input string based on the first result to detect whether the input string matches a predefined password; and
authorizing access to the electronic device in response to the input string matching the predefined password.

2. The method of claim 1, further comprising:
detecting a second gesture performed on a second set of the first objects;
identifying a second operation based on the second gesture and performing the second operation using the respective values of the first objects in the second set as operands to obtain a second result;
wherein identifying the input string includes concatenating the first result with the second result.

3. The method of claim 2, wherein the first set includes at least two of the first objects and the second set includes at least two of the first objects, and the first set and the second set are different from one another.

4. The method of claim 1, further comprising:
displaying, by the electronic device, a second screen including a plurality of second objects each second object being associated with a respective value;
detecting a second gesture performed on a second set of the second objects;
identifying a second operation based on the second gesture and performing the second operation using the respective values of the second objects in the second set as operands to obtain a second result;
wherein identifying the input string includes concatenating the first result with the second result.

5. The method of claim 4, wherein the first set includes at least two of the first objects and the second set includes at least two of the second objects, and the first set and the second set are different from one another.

6. The method of claim 1, wherein computing the input string further comprises concatenating the first result with another result.

7. The method of claim 1, wherein the respective value of at least one of the first objects includes a name corresponding to a person.

8. The method of claim 1, wherein the respective value of at least one of the first objects includes a picture.

9. The method of claim 1, wherein the first operation includes an arithmetic operation.

10. The method of claim 1, wherein the first operation includes a logical operation.

11. An apparatus for authentication comprising a processing circuitry configured to:
display a first screen including first objects, each first object being associated with a respective value;
detect a first gesture performed on a first set of the first objects;
identify a first operation based on the first gesture and perform the first operation using the respective values of the first objects in the first set as operands to obtain a first result;
compute an input string based on the first result to detect whether the input string matches a predefined password; and
authorize access to the apparatus in response to the input string matching the predefined password.

12. The apparatus of claim 11, wherein the processing circuitry is further configured to:
detect a second gesture performed on a second set of the first objects;
identify a second operation based on the second gesture and perform the second operation using the respective values of the first objects in the second set as operands to obtain a second result;
wherein identifying the input string includes concatenating the first result with the second result.

13. The apparatus of claim 12, wherein the first set includes at least two of the first objects and the second set includes at least two of the first objects, and the first set and the second set are different from one another.

14. The apparatus of claim 11, wherein the processing circuitry is further configured to:
display a second screen including a plurality of second objects each second object being associated with a respective value;
detect a second gesture performed on a second set of the second objects;
identify a second operation based on the second gesture and perform the second operation using the respective values of the second objects in the second set as operands to obtain a second result;
wherein identifying the input string includes concatenating the first result with the second result.

15. The apparatus of claim 14, wherein the first set includes at least two of the first objects and the second set includes at least two of the second objects, and the first set and the second set are different from one another.

16. The apparatus of claim 11, wherein computing the input string further comprises concatenating the first result with another result.

17. The apparatus of claim 11, wherein the respective value of at least one of the first objects includes a name corresponding to a person.

18. The apparatus of claim 11, wherein the respective value of at least one of the first objects includes a picture.

19. The apparatus of claim 11, wherein the first operation includes an arithmetic operation.

20. The apparatus of claim 11, wherein the first operation includes a logical operation.

21. The apparatus of claim 11, wherein the processing circuitry includes at least one of a microcontroller, a microprocessor, a processing unit, and a general purpose processor.
